(19) United States
(12) Patent Application Publication
(10) Pub. No.: US 2022/0374804 A1
(43) Pub. Date: Nov. 24, 2022

(54) RESOURCE AVAILABILITY PREDICTION

(71) Applicant: Hewlett-Packard Development Company, L.P., Spring, TX (US)

(72) Inventors: Ravindra Ramtekkar, Pune (IN); Narendra Kumar Chincholikar, Pune (IN); Mohit SONJE, Pune (IN)

(21) Appl. No.: 17/740,727

(22) Filed: May 10, 2022

(30) Foreign Application Priority Data
May 18, 2021 (IN) 202141022262

(51) Int. Cl. G06Q 10/06; G06Q 10/02

(52) U.S. Cl. CPC G06Q 10/06314; G06Q 10/02

(57) ABSTRACT

In some examples, resource availability prediction can include a non-transitory machine-readable medium having instructions thereon executable to receive at the first processing resource, the memory resource, or both, a plurality of input data from a plurality of sources comprising a first plurality of sensors to monitor a plurality of workstations and write from the first processing resource to the memory resource the received input data. The instructions can be executable to identify at the first processing resource or a second processing resource, output data representative of a resource availability prediction based on input data representative of the written data, receive from a mobile device accessible by a user, a request for the resource availability prediction, and transmit the output data to the mobile device via signaling sent via a radio in communication with a third processing resource of the mobile device.

### BACKGROUND

Artificial intelligence (AI) can be used in conjunction with memory resources. AI can include a controller, computing device, or other system to perform a task that normally requires human intelligence. AI can include the use of one or more machine learning models. As described herein, the term “machine learning” refers to a process by which a computing device is able to improve its own performance through iterations by continuously incorporating new data into an existing statistical model. Machine learning can facilitate automatic learning for computing devices without human intervention or assistance and adjust actions accordingly.

### BRIEF DESCRIPTION OF THE DRAWINGS

FIG. 1 illustrates an example of a system including sensors for resource availability prediction.

FIG. 2 illustrates another example of a system including a sensor, a microcontroller, and cloud storage for resource availability prediction.

FIG. 3 illustrates an example of a processing resource in communication with a memory resource storing instructions for resource availability prediction.

FIG. 4 illustrates an example of sensors and a processing resource in communication with a memory resource storing instructions for resource availability prediction.

FIG. 5 illustrates a flow diagram representing an example method for resource availability prediction.

### DETAILED DESCRIPTION

Office resources such as workstations, conferences rooms, parking spaces, cafeterias, lobby areas, and other spaces can be occupied or used by employees on a first come-first serve basis. In such examples, conflicts between the resource utilization at a given time and place may occur, resulting in lost work productivities. For instance, multiple employees may come into an office at the same time to find that enough workstations are not available, parking is not available, conference rooms are full, or other resource availability issues. The employee may have to return home or wait for an available workstation, conference room, etc., which can result in frustration and lost work productivity. As used herein, a workstation may include a workspace with a computing device (e.g., an office, a cubicle), a desk available to plug in a computing device, or other workspace where work of a particular nature is carried out.

Computing devices can be utilized in a non-portable setting, such as at a desktop, and/or be portable to allow a user to carry or otherwise bring the computing device along while in a mobile setting. These computing devices can be communicatively coupled to other computing devices and/or computing resources to perform particular functions. As used herein, the term computing device refers to an electronic system having a processor resource and a memory resource. Examples of computing devices can include, for instance, a laptop computer, a notebook computer, a desktop computer, an all-in-one (AIO) computer, networking device (e.g., router, switch, etc.), and/or a mobile device (e.g., a smart phone, tablet, personal digital assistant, smart glasses, a wrist-worn device such as a smart watch, etc.), among other types of computing devices. As used herein, a mobile device refers to devices that are (or can be) carried and/or worn by a user. In some examples, the computing device can be communicatively coupled to a cloud storage resource.

The present disclosure relates to allocation, sharing, and predicting availability of resources such as workspaces, conference rooms, parking, entertainment venues, entertainment seating, etc. for a particular date, location, and time. Using Internet of Things (IoT) enabled devices and machine learning, resource availability can be predicted and shared more efficiently and effectively. For example, based on a predicted availability of resources, users can reserve resources in advance to confirm use of those resources at particular times and locations. As used herein, an IoT enabled device can refer to a device embedded with electronics, software, sensors, actuators, and/or network connectivity which enable such devices to connect to a network and/or exchange data. Examples of IoT enabled devices include mobile phones, smartphones, tablets, phablets, computing devices, implantable devices, vehicles, home appliances, smart home devices, monitoring devices including sensors, wearable devices, devices enabling intelligent shopping systems, among other cyber-physical systems.

FIG. 1 illustrates an example of a system including sensors 100-1, 100-2, 100-2, . . . , 100-n for resource availability prediction. A sensor, as used herein, can include a device, module, machine, or subsystem whose purpose is to detect events or changes in its environment and send the information to other electronics. For instance, a sensor may detect movement in a room and transmit that data to processing resource of a microcontroller or other device.

The sensors 100 can detect events or changes at a workstation 104, for instance. While the example illustrated in FIG. 1 includes sensors 100 at a workstation 104, the sensors 100 may be located elsewhere, including, for instance, a parking lot, parking spots (e.g., regular parking, electronic vehicle parking, handicapped parking, etc.), parking garage, a workplace cafeteria, a conference room, workplace lobby, open areas of a workplace (e.g., free space for conducting activities), a shopping mall, a movie theater, etc. The sensors 100 can detect resource usage (e.g., computing devices, printers, copiers, programs, etc.) including consumption patterns and flow, employee density levels (e.g., a busy cafeteria), and environmental factors (e.g., humidity, temperature, etc.).

In some examples, the sensors 100 and other sensors can work in combination with a desk booking system that tracks where employees choose to sit, how departments work together, how much time each employee spends in the office, and which workstations get most use. Sensor data can also help determine which areas in a workplace are most popular and which areas are underused, as well as giving environmental insight such as sound quality, air quality, lighting, temperature, etc. For instance, a user may not want to travel to the workplace if the cooling system is not working and the current temperature is too high.

The sensors 100 and other sensors can include desk or chair sensors to track how employees use their desk area. Sensors 100 and other sensors may also include tracking devices in identification cards to track working hours, breaks, time spent in meetings, and teamwork. Area sensors that track general movement may be used to determine how often spaces are used and for what purpose.

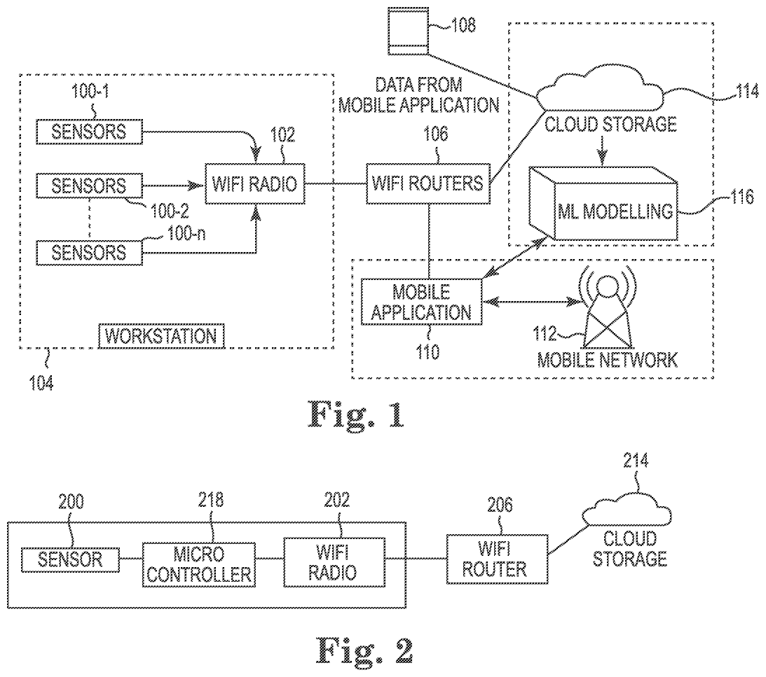

The events and changes detected by the sensors 100 can be transmitted to a Wi-fi radio 102, a Wi-fi router 106, and further transmitted to cloud storage 114, as will be further discussed herein with respect to FIG. 2. The data detected by the sensors 100 can be used, along with additional data, by a prediction tool 116 that uses a machine learning model to predict resource availability. The prediction tool 116 can include, in some examples, a processing resource in communication with a memory resource that utilizes machine learning to predict resource availability. Put another way, the prediction tool 116 determines which resources are available at particular times, dates, and locations for a user based on data available to the prediction tool 116.

Data available to the prediction tool 116 can come from sources other than the sensors 100, in some examples. For instance, a user my access an application downloaded on a mobile device 108, 110 (e.g., tablet, smartphone, etc.) connected to a mobile network 112, and data collected by the application can be transmitted to the cloud storage 114 and/or the Wi-fi router 106 and subsequently the cloud storage 114. For example, a user may manually input data into the application 108 for consideration during machine learning at the prediction tool 116, such as desired times, dates, locations (e.g., particular workstations, near particular coworkers, parking locations, etc.). The application 110 may gather data associated with the user, such as location data, travel habits, sleep habits (e.g., a smartwatch), etc. that can be transmitted to the Wi-fi router 106 and the cloud storage 114 for use in predicting resource usage at the prediction tool 116.

The machine learning model(s) used by the prediction tool 116 can be a supervised learning model such as a random forest and logistic regression machine learning model. The supervised learning model can be chosen, data received and stored at the cloud storage 114 including historical data, can be trained and tested, and the machine learning model can be built. The training, for instance, can include using historical data to create the machine learning model, update the machine learning model, and improve accuracy and efficiency of the machine learning model. In some examples, input data may carry different weights. The processes can be iterated until a desired accuracy threshold is obtained by the machine learning model.

When a resource availability prediction is made, the result can be transmitted to a user, for instance via the mobile application 110. The user may request a particular time, date, and location for a resource, and the prediction tool 116 can provide the use with availability of the resource and/or alternative availabilities of similar resources.

For instance, in a non-limiting example, a user may desire to go to his or her workplace on a particular day, at a particular time, and work at a particular workstation. The user may also desire to park in an electric vehicle parking spot, so he or she may charge his or her car while working. The user may also desire to use a conference room for a team meeting. However, the user may not want to travel to his or her workplace to find that his or her desired resources are unavailable.

In such an example, the user can access an application on his or her mobile device 108, 110, and request the desired day, time, and locations. Based on data received at the prediction tool 116, for instance from sensors 100 at the desired workstation and other workstations at the workplace, sensors in the electric vehicle parking spot and other parking areas, sensors in conference rooms at the workplace, and historical data such as historical workspace availability, historical work patterns of the user and other employees, seasonality availability (e.g., less busy at certain holidays, days of the week, times of day, etc.), the machine learning model can be used to determine a real time availability prediction of the user's requested resources.

The user can receive via the application on his or her mobile device 108, 110, the resource availability prediction. Based on the results, the user can reserve the desired resource(s). Scheduled reservations, for instance reserving a same parking spot on Mondays, Wednesdays, and Fridays, may be requested via the application 110. In some examples, a user may be prompted to reserve a parking spot in response to a different resource reservation (e.g., a workstation on conference room reservation) being made. A user may cancel or reschedule a reservation, in some examples, for instance via the application 110. This can be updated automatically (e.g., without user intervention, in real time) in the machine learning model, so the reservation can be made available to others.

In some examples, some or all of the requested resources may not be available. The user can be offered alternatives, for instance different times, dates, or locations. For instance, a user may be offered an alternative parking space or workstation that is available during the desired time. The alternates offered may be presented by most similar (e.g., also an electronic vehicle space, nearby workstation, etc.) to least similar (e.g., different parking space type, different day, etc.).

In some examples, the user may be presented with a probability of workspace resource availability. For instance, a conference room may be reserved at 10:00 AM for one hour, but the machine learning model may suggest that the user who reserved the conference room often goes over his or her time. A probability for the conference room to be available at 11:00 AM may be presented accordingly.

In some instances, an administrative version of the application may be available to an administrator for management. For instance, the administrator may be able to override reservations or monitor usage of the workstations and other reservable resources. An administrator, in some examples, may be presented with suggestions to reduce workstations numbers or parking spaces if it is determined that particular spaces or workstations are underused.

FIG. 2 illustrates another example of a system including a sensor 200, a microcontroller 218, and cloud storage 214 for resource availability prediction. FIG. 2 illustrates examples of data collection using sensors and Wi-fi. For instance, a sensor 200 can be interfaces with a microcontroller 218 and a Wi-fi radio 202. The sensor 200 may include, for instance, an infrared (IR) sensor or an ultrasonic sensor, among others. A microcontroller, as used herein is a compact integrated circuit that may include or be communicatively coupled to a processor, a storage device, and/or input/output (I/O) peripherals.

The Wi-fi radio 202 can include a transmitter to transmit the data and a receiver for connection. The Wi-fi radio 202 can support creation of its own ad-hoc network and connection to other networks. The Wi-fi radio 202 can be configured wireless and can provide analog and digital I/O connections, in some examples. In such instances, the Wi-Fi radio 202 may be used without the microcontroller 218.

The sensor 200 receives signaling representative of input data, and the microcontroller 218 detects the signaling. The microcontroller 218 can allow for performance of computational tasks based on sensory input before forwarding the data to a prediction tool. For example, the microcontroller 218 may check whether the input from each sensor 200 has changed significantly enough to be forwarded or undertake some processing of the sensor input to reduce data to be transmitted, which can reduce a data cleaning task for the machine learning model as the data from the sensor 200 is check before transmitting it to cloud storage 214.

The input data is transmitted via the Wi-fi radio 202 to a Wi-fi router 206 and transmitted to cloud storage 214. The data stored in the cloud storage 214 can be used in a machine learning model to predict resource availability. In some examples, the sensor 200 can near-continuously (e.g., without meaningful breaks) receive signaling and transmit the signaling to the cloud storage 214 (e.g., via the microcontroller 218, Wi-fi radio 202, and Wi-fi router 206).

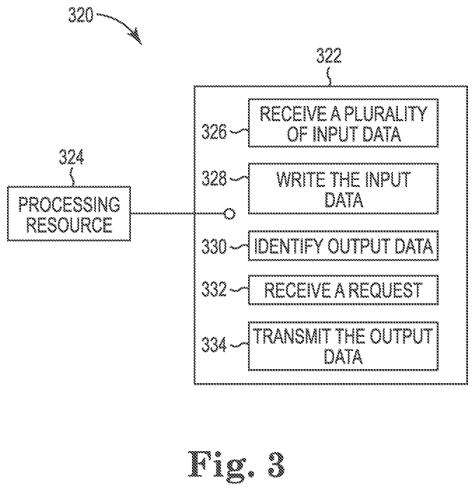

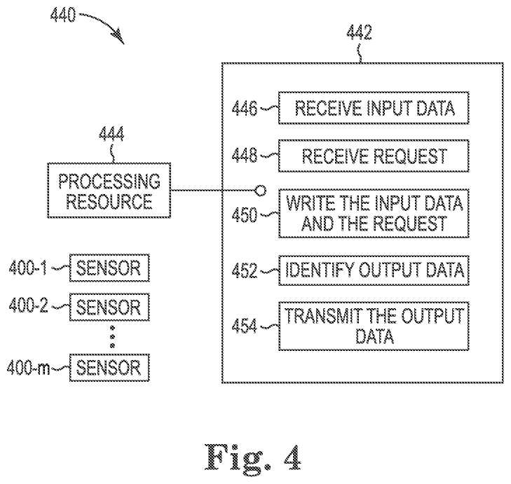

FIG. 3 illustrates an example of a processing resource 324 in communication with a memory resource 322 storing instructions 326, 328, 330, 332, 334 for resource availability prediction. In some examples, the processing resource 324 and memory resource 322 comprise a system 320 such as a prediction tool (e.g., prediction tool 116 illustrated in FIG. 1).

The system 320 illustrated in FIG. 3 can be a server or a computing device (among others) and can include the processing resource 324. The system 320 can further include the memory resource 322 (e.g., a non-transitory MRM), on which may be stored instructions, such as instructions 326, 328, 330, 332, 334. Although the following descriptions refer to a processing resource and a memory resource, the descriptions may also apply to a system with multiple processing resources and multiple memory resources. In such examples, the instructions may be distributed (e.g., stored) across multiple memory resources and the instructions may be distributed (e.g., executed by) across multiple processing resources.

The memory resource 322 may be electronic, magnetic, optical, or other physical storage device that stores executable instructions. Thus, the memory resource 322 may be, for example, non-volatile or volatile memory. For example, non-volatile memory can provide persistent data by retaining written data when not powered, and non-volatile memory types can include NAND flash memory, NOR flash memory, read only memory (ROM), Electrically Erasable Programmable ROM (EEPROM), Erasable Programmable ROM (EPROM), and Storage Class Memory (SCM) that can include resistance variable memory, such as phase change random access memory (PCRAM), three-dimensional cross-point memory, resistive random access memory (RRAM), ferroelectric random access memory (FeRAM), magnetoresistive random access memory (MRAM), and programmable conductive memory, among other types of memory. Volatile memory can require power to maintain its data and can include random-access memory (RAM), dynamic random-access memory (DRAM), and static random-access memory (SRAM), among others.

In some examples, the memory resource 322 is a non-transitory MRM comprising Random Access Memory (RAM), an Electrically-Erasable Programmable ROM (EEPROM), a storage drive, an optical disc, and the like. The memory resource 322 may be disposed within a controller and/or computing device. In this example, the executable instructions 326, 328, 330, 332, 334 can be “installed” on the device. Additionally, the memory resource 322 can be a portable, external or remote storage medium, for example, that allows the system to download the instructions 326, 328, 330, 332, 334 from the portable/external/remote storage medium. In this situation, the executable instructions may be part of an “installation package”. As described herein, the memory resource 322 can be encoded with executable instructions for a resource availability prediction.

The instructions 326, when executed by a processing resource such as the processing resource 324 (herein after referred to as the “first processing resource 324”), can include instructions to receive at the first processing resource 324, the memory resource 322, or both, a plurality of input data from a plurality of sources. The plurality of sources can include a first plurality of sensors to monitor a plurality of workstations and/or other sensors associated with the workplace. For instance, in some examples, the plurality of sources can include a sensor to monitor conference room activity, a mobile device, a sensor to monitor parking activity, an environmental sensor, and/or a second plurality of sensors to monitor portions of a building housing the workstations, among others. In some instances, the plurality of sources can include data from a mobile device of a user of the workplace such as location data or work pattern data. A user may manually enter data into the mobile device, for instance via an application, in some examples.

The instructions 328, when executed by a processing resource such as the first processing resource 324 can include instructions to write from the first processing resource 324 to the memory resource 322 the received input data. Such data can be stored in the memory resource 322 for use in predicting resource availability. For instance, the data can be used to predict an availability of workstations, parking space, conference rooms, or cafeteria space, among others. In non-workplace related examples, the data can be used to predict an availability of seating or parking at a theater, restaurant or shopping mall, for instance.

The instructions 330, when executed by a processing resource such as the first processing resource 324 can include instructions to identify at the first processing resource 324 or a second processing resource, output data representative of a resource availability prediction including an availability of each one of the plurality of workstations based on input data representative of the data written from the first processing resource 324. The output data, in some examples can be representative of a resource availability prediction of other resources such as parking spots, conference rooms, or other resources.

In some examples, machine learning model such as a random forest and logic regression machine learning model can be used to identify the output data representative of the resource availability prediction. For example, the machine learning model can use all or some of the input data to determine resource availability predictions. In some instances, the resource availability predictions may be sorted based on matches to desired resources. For instance, a workstation that is available within 30 minutes of a user's desired time may be prioritized over a workstation that is available a day after the user's desired time. The user can indicate these desired times by making a request via an application downloaded on a mobile device.

For instance, the instructions 332, when executed by a processing resource such as the first processing resource 324 can include instructions to receive from a mobile device accessible by a user, a request for the resource availability prediction. The request, for instance, can include a desired time, a desired location, and a desired date for the user to utilize a workstation of the plurality of workstations. The user can access an application and indicate what resources he or she would like to access and when. For instance, the user can indicate a particular conference room on a particular date and time. The user may subsequently be prompted via the application to request a parking space, in some examples.

The instructions 334, when executed by a processing resource such as the first processing resource 324 can include instructions to transmit the output data representative of the resource availability prediction to the mobile device via signaling sent via a radio in communication with a third processing resource of the mobile device. The output data, for instance, can include a predicted availability of the requested desired time, desired location, and desired date. For instance, based on the request from the user, the machine learning model can predict resource availability and transmit that information to the user via the application.

In some examples, the memory resource 322 can include instructions executable to receive an additional request to reserve the workstation of the plurality of workstations responsive to a positive predicted availability reserve the workstation of the plurality of workstations in response to the additional request. The user can request to reserve the workstation or other resource, and the reservation can be made in real time. In some examples, the user may be provided with alternative suggestions if there is a negative predicted availability for the requested workstation and times. The user may reserve and alternative or cancel the request. In some instances, the user may be notified via the application if the requested workstation becomes available, for instance if someone else cancels a reservation.

FIG. 4 illustrates an example of sensors 400-1, 400-2, . . . , 400-m and a processing resource 440 in communication with a memory resource 442 storing instructions 446, 448, 450, 452, 454 for resource availability prediction. In some examples, the processing resource 444 (herein after referred to as “the first processing resource 444”) and the memory resource 442 may be analogous to processing resource 324 and memory resource 322, respectively, as described with respect to FIG. 3.

In some examples, the first processing resource 444, the sensors 400, and the memory resource 442 comprise a system 440, wherein the processing resource 444 and the memory resource 442 comprise a prediction tool such as prediction tool 116 illustrated in FIG. 1. In some examples, the first processing resource 444 and the memory resource 442 may be analogous to the first processing resource 324 and the memory resource 322 illustrated in FIG. 3.

The instructions 446, when executed by a processing resource such as the first processing resource 444 can include instructions to receive at the first processing resource 444, input data comprising first signaling from a radio in communication with each one of the plurality of sensors 400. The plurality of sensors 400 can include, for instance, sensors to monitor workstation resources, workstation availability, resource consumption patterns, workstation density, environmental information, activity patterns, parking availability, or any combination thereof. In some examples, the plurality of sensors 400 is located in an entertainment venue such as a restaurant, shopping mall, or theater and can monitor crowds, seat availability, environmental information, etc.

The instructions 448, when executed by a processing resource such as the first processing resource 444 can include instructions to receive, at the first processing resource 444, second signaling from a second radio in communication with a second processing resource, wherein the second signaling comprises a request for the resource availability prediction of a particular one of the plurality of resources and associated with a desired time, a desired location, and a desired date. For instance, the request may come via an application that a user has accessed on their mobile phone (e.g., having the second processing resource) to request use of resources such as workstations or parking spaces, among others, at a desired time, location, and date.

The instructions 450, when executed by a processing resource such as the first processing resource 444 can include instructions to write from the first processing resource 444 to the memory resource 442 the received input data and the received request. Such data can be stored in the memory resource 442 for use in predicting resource availability.

The instructions 452, when executed by a processing resource such as the first processing resource 444 can include instructions to identify, at the first processing resource 444 or a second processing resource and using a machine learning model, output data representative of a resource availability prediction including an availability of each one of a plurality of resources including the particular one of the plurality of resources at the desired time, the desired location, and the desired date, based on input data representative of the data written from the first processing resource 444. For instance, using the data gathered by the plurality of sensors 400, a prediction can be made as to availability of resources at particular times, dates, and locations.

In some examples, the machine learning model can be updated in response to receiving first signaling, second signaling, or both. For instance, as resource availability goes down (e.g., someone reserves a conference room), or resource availability goes up (e.g., some cancels a reservation), the machine learning model can be updated in real time. Historical data used in the machine learning model can be updated, in some examples, as more data is gathered by the plurality of sensors 400.

The instructions 454, when executed by a processing resource such as the first processing resource 444 can include instructions to transmit the output data representative of the resource availability prediction to the second processing resource. For instance, the resource availability prediction can be transmitted to the user's mobile device via the application. The output data may include availability of resources in real time, and may provide alternative times, dates, and locations if the desired times, dates, and locations are unavailable.

For instance, the particular one of the plurality of resources at the desired time, the desired location, and the desired date can be reserved in response to the resource availability prediction indicating the one of the plurality of resources is available at the desired time, the desired location, and the desired date. An alternate resource suggestion can be provided in response to the resource availability prediction indicating the one of the plurality of resources is not available at the desired time, the desired location, and the desired date, and if desired, the alternate resource suggestion may be reserved. In some instances, the user may be provided with a prompt via the application if his or her first desired time, date, or location for a resource becomes available (e.g., another user cancels a reservation).

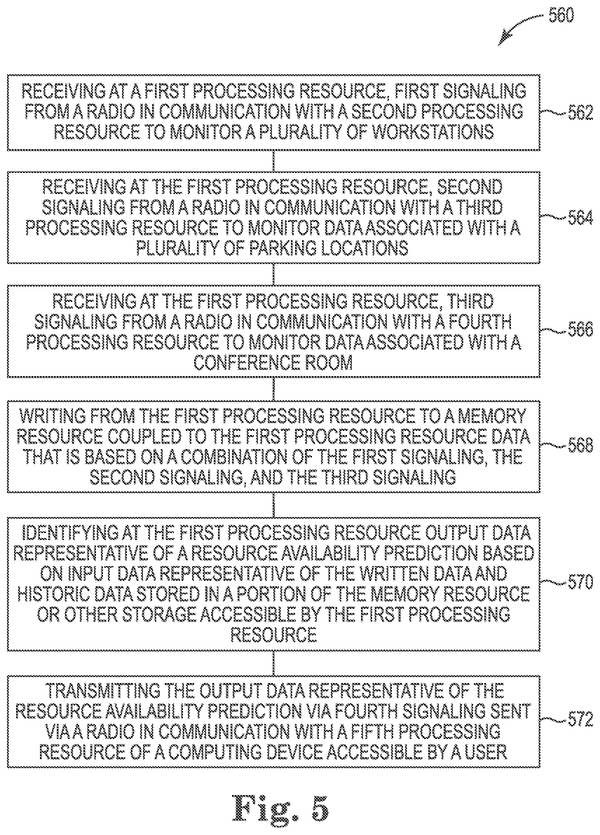

FIG. 5 illustrates a flow diagram representing an example method 560 for resource availability prediction. The method 560 can be performed by a system such as the systems described with respect to FIGS. 1, 3, and 4. The method 560 illustrates an example of resource availability prediction using a prediction tool such as prediction tool 116.

At 562, the method 560 can include receiving at a first processing resource, first signaling from a radio in communication with a second processing resource to monitor a plurality of workstations, and at 564, the method 560 can include receiving at the first processing resource, second signaling from a radio in communication with a third processing resource to monitor data associated with a plurality of parking locations. At 566, the method 560 can include receiving at the first processing resource, third signaling from a radio in communication with a fourth processing resource to monitor data associated with a conference room. The first signaling, the second signaling, and the third signaling can be received from a plurality of sensors located at the workstations, around the workplace, in a parking lot or parking garage, in parking spaces, in the conference room, etc. In some examples, the sensors can include cameras.

The method 560, at 568, can include writing from the first processing resource to a memory resource coupled to the first processing resource data that is based on a combination of the first signaling, the second signaling, and the third signaling. For instance, the data can include how many people are present at the resources (e.g., workstations, parking locations, and/or conference room), and/or the data may also include how the resources are being used, among other data.

In some examples, the method 560 can include receiving at the first processing resource via the application of a mobile device of the user, manual input from the user comprising user data, an appointment request, or a combination thereof and writing from the first processing resource to a memory resource coupled to the first processing resource data that is based on a combination of the first signaling, the second signaling, the third signaling, and the manual input. For instance, the user may indicate that he or she will be away from the workplace for a particular holiday, or may cancel previously made reservations, which can be used in making a resource availability prediction. A user may, in some examples, request a particular time, data, and location for use of a resource via the application, in some examples.

At 570, the method 560 can include identifying at the first processing resource output data representative of a resource availability prediction based on input data representative of the written data and historic data stored in a portion of the memory resource or other storage accessible by the first processing resource. The historic data, for instance, can include previously received signaling and associated data associated with resource availability predictions. In some examples, identifying the output data includes utilizing a machine learning model to identify the output data representative of the resource availability prediction based on data associated with the first signaling, the second signaling, the third signaling, and the historic data. For instance, using the first signaling, the second signaling, the third signaling, and the historic data the machine learning model can determine a current availability of resources, a future availability of resource, and alternative availability of resources. Manual input, in some examples, may also be used to predict available resources. As additional signaling is received, the machine learning model can be updated to reflect updated resource availabilities.

At 572, the method 560 can include transmitting the output data representative of the resource availability prediction via fourth signaling sent via a radio in communication with a fifth processing resource of a computing device accessible by a user. For instance, the output data can be transmitted to a mobile device or other computing device of the user via an application. Upon requesting the use of particular resources via the application, the user can receive the resource availability prediction via the application indicating if the particular resources are available as desired. If they are available, the user can reserve the particular resources. If they are not available as desired, the user may be presented with alternatives and can reserve the alternatives via the application or cancel the request.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure. Further, as used herein, “a” refers to one such thing or more than one such thing.

The figures herein follow a numbering convention in which the first digit corresponds to the drawing figure number and the remaining digits identify an element or component in the drawing. For example, reference numeral 102 may refer to element 102 in FIG. 1 and an analogous element may be identified by reference numeral 202 in FIG. 2. Analogous elements within a Figure may be referenced with a hyphen and extra numeral or letter. See, for example, elements 100-1 and 100-2 in FIG. 1. Such analogous elements may be generally referenced without the hyphen and extra numeral or letter. For example, elements 100-1 and 100-2 may be collectively referenced as 100. Elements shown in the various figures herein can be added, exchanged, and/or eliminated to provide additional examples of the disclosure. In addition, the proportion and the relative scale of the elements provided in the figures are intended to illustrate certain examples of the present invention and should not be taken in a limiting sense.

It can be understood that when an element is referred to as being “on,” “connected to”, “coupled to”, or “coupled with” another element, it can be directly on, connected, or coupled with the other element or intervening elements may be present. In contrast, when an object is “directly coupled to” or “directly coupled with” another element it is understood that are no intervening elements (adhesives, screws, other elements) etc.

The above specification, examples, and data provide a description of the system and method of the disclosure. Since many examples can be made without departing from the spirit and scope of the system and method of the disclosure, this specification merely sets forth some of the many possible example configurations and implementations.

What is claimed is:

1. A non-transitory machine-readable medium comprising a first processing resource in communication with a memory resource having instructions executable to:
receive at the first processing resource, the memory resource, or both, a plurality of input data from a plurality of sources, the plurality of sources comprising a first plurality of sensors to monitor a plurality of workstations;
write from the first processing resource to the memory resource the received input data;
identify at the first processing resource or a second processing resource, output data representative of a resource availability prediction including an availability of each one of the plurality of workstations based on input data representative of the data written from the first processing resource;
receive from a mobile device accessible by a user, a request for the resource availability prediction; and
transmit the output data representative of the resource availability prediction to the mobile device via signaling sent via a radio in communication with a third processing resource of the mobile device.

2. The medium of claim 1, wherein the plurality of sources further comprises a sensor to monitor conference room activity.

3. The medium of claim 1, wherein the plurality of sources further comprises the mobile device.

4. The medium of claim 1, wherein the plurality of sources further comprises a sensor to monitor parking activity.

5. The medium of claim 1, wherein the plurality of sources further comprises a second plurality of sensors to monitor portions of a building housing the workstations.

6. The medium of claim 1, wherein:
the request comprises a desired time, a desired location, and a desired date for the user to utilize a workstation of the plurality of workstations; and
the output data comprises a predicted availability of the desired time, the desired location, and the desired date.

7. The medium of claim 1, further comprising instructions executable to:
receive an additional request to reserve the workstation of the plurality of workstations responsive to a positive predicted availability; and
in response to the additional request, reserve the workstation of the plurality of workstations.

8. The medium of claim 1, further comprising the instructions executable to identify at the first processing resource or the second processing resource output data representative of the resource availability prediction using a random forest and logic regression machine learning model.

9. A method, comprising:
receiving at a first processing resource, first signaling from a radio in communication with a second processing resource to monitor a plurality of workstations;
receiving at the first processing resource, second signaling from a radio in communication with a third processing resource to monitor data associated with a plurality of parking locations;
receiving at the first processing resource, third signaling from a radio in communication with a fourth processing resource to monitor data associated with a conference room;
writing from the first processing resource to a memory resource coupled to the first processing resource data that is based on a combination of the first signaling, the second signaling, and the third signaling;
identifying at the first processing resource output data representative of a resource availability prediction based on input data representative of the written data and historic data stored in a portion of the memory resource or other storage accessible by the first processing resource; and
transmitting the output data representative of the resource availability prediction via fourth signaling sent via a radio in communication with a fifth processing resource of a computing device accessible by a user.

10. The method of claim 9, wherein identifying the output data representative of the resource availability prediction comprises utilizing a machine learning model to identify the output data representative of the resource availability prediction based on data associated with the first signaling, the second signaling, the third signaling, and the historic data,
wherein the historic data comprises previously received signaling and associated data associated with resource availability predictions.

11. The method of claim 9, further comprising:
receiving at the first processing resource via an application of a mobile device of the user, manual input from the user comprising user data, an appointment request, or a combination thereof; and
writing from the first processing resource to a memory resource coupled to the first processing resource data that is based on a combination of the first signaling, the second signaling, the third signaling, and the manual input.

12. A system, comprising:
a plurality of sensors; and
a non-transitory machine-readable medium comprising a first processing resource in communication with a memory resource having instructions executable to:
receive at the first processing resource, input data comprising first signaling from a radio in communication with each one of the plurality of sensors;
receive, at the first processing resource, second signaling from a second radio in communication with a second processing resource, wherein the second signaling comprises a request for the resource availability prediction of a particular one of the plurality of resources and associated with a desired time, a desired location, and a desired date;
write from the first processing resource to the memory resource the received input data and the received request;
identify, at the first processing resource or a second processing resource and using a machine learning model, output data representative of a resource availability prediction including an availability of each one of a plurality of resources including the particular one of the plurality of resources at the desired time, the desired location, and the desired date, based on input data representative of the data written from the first processing resource; and
transmit the output data representative of the resource availability prediction to the second processing resource.

13. The system of claim 12, further comprising instructions executable to:
reserve the particular one of the plurality of resources at the desired time, the desired location, and the desired date in response to the resource availability prediction indicating the one of the plurality of resources is available at the desired time, the desired location, and the desired date;
provide an alternate resource suggestion in response to the resource availability prediction indicating the one of the plurality of resources is not available at the desired time, the desired location, and the desired date.

14. The system of claim 12, further comprising instructions executable to update the machine learning model in response to receiving first signaling, second signaling, or both.

15. The system of claim 12, wherein the plurality of sensors comprises sensors to monitor workstation resources, workstation availability, resource consumption patterns, workstation density, activity patterns, parking availability, or any combination thereof.
